(19) United States
(12) Patent Application Publication
(10) Pub. No.: US 2020/0272453 A1
(43) Pub. Date: Aug. 27, 2020

(54) Real-Time Version Controller

(71) Applicant: salesforce.com, inc., San Francisco, CA (US)

(72) Inventors: Gaston Alberto LODIEU, Buenos Aires, CA (US); Diego Gabriel LARRALDE, Buenos Aires, CA (US); Leandro Damián LÜCK, Buenos Aires, CA (US)

(21) Appl. No.: 16/281,721

(22) Filed: Feb. 21, 2019

(51) Int. Cl. G06F 8/656; G06F 8/71; H04L 29/08; G06F 9/50; G06F 9/455

(52) U.S. Cl. CPC G06F 8/656; G06F 8/71; H04L 67/2814; H04L 67/34; G06F 2009/45562; G06F 9/5077; G06F 9/45558; G06F 2009/45575; H04L 67/10

(57) ABSTRACT

Disclosed herein are system, method, and computer program product embodiments for providing real-time version control operations. An embodiment operates by determining, based on a mapping, that an initial call to a function in accordance with an application programming interface (API) received by a computing device is directed to first location corresponding to a first implementation of the function. A second implementation of the function is determined to be available at a second location. The mapping is updated to include the second location, wherein a subsequent call to the function received by the computing device after the updating is directed to the second location, wherein the first implementation remains available until at least the updating has completed.

### BACKGROUND

In smaller computing system environments, in which limited computing resources are available to provide web services, administrators often have to balance service availability with maintenance. Routine maintenance, such as code changes, often requires the system administrators to shut down existing services to update the code. After the update has been applied, the administrators may then restart the web services. However this service interruption may limit both system throughput and reliability. This service downtime may also be problematic for the different clients that may be relying on and expecting the web services to remain available and accessible without downtime or other outages.

### BRIEF DESCRIPTION OF THE DRAWINGS

The accompanying drawings are incorporated herein and form a part of the specification.

FIG. 1 is a block diagram illustrating example functionality for providing a real-time version control system according to some embodiments.

FIG. 2 is a flowchart illustrating example operations of a real-time version controller (RVC), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a real-time version controller.

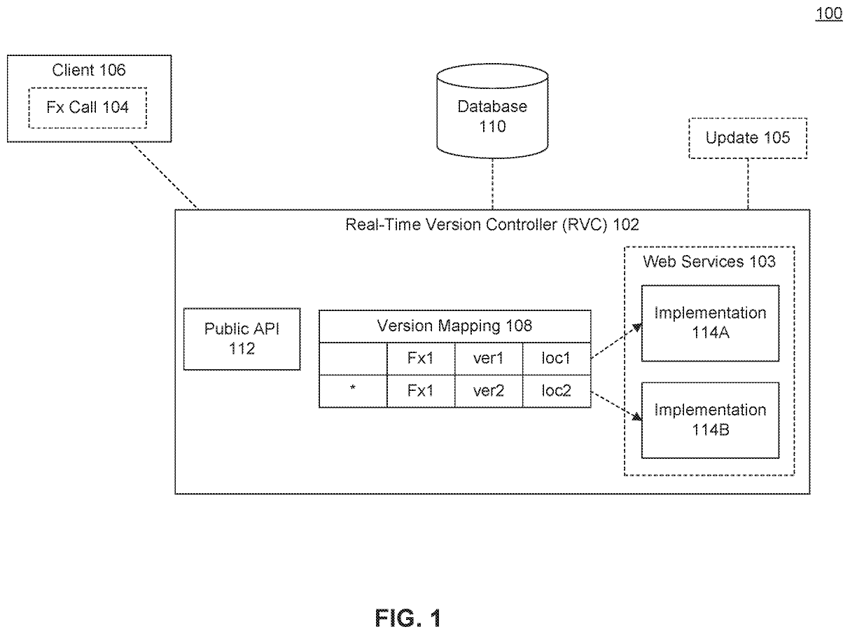

FIG. 1 is a block diagram 100 illustrating example functionality for providing a real-time version control system according to some embodiments. In the example system, a real-time version controller (RVC) 102 may increase system availability and throughput of web services 103 in smaller computing system environments.

Web services 103 may include any services or computing functionality which are accessible over a network (such as the Internet) by one or more clients. Example web services 103 may enable clients or users to access/modify data of a database 110, upload data, download data, or perform any other computing function. In an embodiment, the web services 103 may receive a request from a client 106 and generate or provide a response to the client 106.

In an embodiment, web services 103 may be made available through one or more servers of a backend system environment that receive requests (such as function calls 104) from clients 106. An example of such a backend system environment may include a cloud networking environment. The cloud may include a system of multiple interconnected computing devices that enable access to particular functionality, including redundancy, to a set of clients.

However, not all web services 103 operate on the cloud, and may instead operate in smaller system environments, including single server or single computing device backends that are configured to receive and process a limited number or limited types of client requests. In an embodiment, a smaller system environment may include multiple servers or other computing devices but with limited or no redundancy, such that each server is responsible for providing a specific set of functionality associated with web services 103 for clients requesting the assigned functionality. For example, a first server may be responsible for financial transactions of web services 103 and a second server may be responsible for personnel transactions of web services 103.

In smaller system computing environments, installing updates to live implementations of a function or other web service that is accessible to clients often requires system downtime. For example, an administrator (or developer) must first stop the live version of the functionality—thus making it inaccessible to clients. Only when the live version is stopped can the administrator install or instantiate the updated version of the functionality and redirect any future requests to updated version on the server(s) handling the updated functionality. After the new version is up and running, the administrator may then shut down or remove the old live version.

However the time gap between shutting down the live version and redirecting new requests to the updated version means that for a period of time at least a portion of the web services (particularly those being updated and any related functionality) are unavailable. This downtime limits system throughput, may cause backups, potential system overloads when the system comes back online, and produces client dissatisfaction. In addition, this downtime process fails to utilize or maximize all the available resources in a computing system environment, whether it is smaller or larger (e.g., cloud).

RVC 102 enables administrators or developers to update the functionality of live web services 103 without incurring the cost of system downtime, particularly in smaller computing environments with limited resources, thus increasing overall system throughput and availability. RVC 102 maximizes or increases the use of available computing resources to enable system or web service 103 updates with limited or no downtime (of a particular computing device or updated functionalities of web services 103) thus avoiding the problems created by the downtime process described above. As described herein, many of the embodiments will focus on single or smaller computing device environments, however it is understood that in other embodiments RVC 102 may operate in or across multiple computing devices (working separately or together).

in the example of FIG. 1, RVC 102 may be operating in a small computing system environment that is configured to make web services 103 available to clients 106. in an embodiment, clients 106 may request or call web services 103 according to a public API (application programming interface) 112. Clients 106 may include user accounts or computing devices that have been provided paid access or other authorization to request at least a portion of the functionality of web services 103. In an embodiment, different clients 106 may have access to different, limited, or particular functions of web services 103.

Public API 112 may include a set of definitions or protocols by which a client 106 may request the execution of one or more functions via a function (fx) call 104. The fx call 104 may include arguments (required or optional) provided by client 106 and as specified by the public API 112. In an embodiment, function calls 104 not in accordance with public API 112 may not be executed.

In an embodiment, RVC 102 may receive a fx call 104 and route the fx call 104 to the location where a corresponding implementation of the called function is available to the requesting client 106. The location may indicate a memory address where a compiled, executable, or executing code of the implementation of the function is stored. In an embodiment, location may include a virtual machine operating any of one or more computing devices, or other actor, node, partition, or machine name where a particular implementation of an identified version of a function may be accessible.

In an embodiment, one or more actors may be used provide the various functionality of web services 103. The actors may allow for concurrent computations in that each actor may be treated as a universal primitive of concurrent computation. In response to a message that it receives, the actor may make local decisions, create more actors, send more messages, or determine to how to respond to the next message received. In an embodiment, while an actor may modify its own private state, it can only affect other actors through sending messages thus avoiding the need for locks.

In an embodiment, RVC 102 may operate on or in conjunction with an Akka platform. Akka may be a toolkit that simplifies the construction of concurrent and distributed applications (particularly on a Java® platform). Akka may support multiple programming models that enable concurrency, but emphasizes actor-based concurrency.

In a multi-server or multi-computing device system, the location may indicate the network or other address of a particular server hosting the requested functionality for the requesting client 106.

In an embodiment, different servers may be dedicated or configured to serve different clients 106. For example, a first RVC 102 may determine a location (media access control (MAC), internet protocol (IP) address, or network name) of a server or group of servers responsible for providing requests for the particular client 106 (in which different computing systems or servers handle requests from different clients). Then a second RVC 102 may be responsible for identifying another location within the server or cluster where the requested functionality is accessible or available for the client 106. in another embodiment, this may be reversed in that the first RVC 102 may identify a server (or cluster of servers) associated with the requested functionality of fx call 104, and the second RVC 102 may identify a location or machine responsible for providing the requested functionality for the particular client 106.

A version mapping 108 may include the location information about where various versions or implementation 11 of the functions or web services 103 are located. Version mapping 108 may include a database, spreadsheet, program, or other data structure that stores or makes available the information described herein. In an embodiment, version mapping 108 may include an active field, a function name field, a version name filed, and a location indicator field. The function name field may indicate the name of a function (e.g., “Fx1”) which may correspond to the defined functions from public API 112. When a fx call 104 is received from a client 106, the requested function may be cross-referenced against version mapping 108 to identify the name or identifier of the called or requested function.

As described above, public API 112 may include a function that has optional arguments. For example, an add user account function may require name and account number arguments, but may have an account balance argument that is optional. In different embodiments, the add user account function may be listed either once regardless of whether optional arguments are included, or may be listed twice: once with the optional arguments, and once without the optional arguments as defined in public API 112.

Upon receiving fx call 104, RVC 102 may identify the corresponding function name in version mapping 108. However a particular function may include multiple different or available versions of the function. For example, version mapping 108 has Fx1 listed twice, once for each available version. WIC 102 may then identify to which version to route fx call 104.

In an embodiment, an active field (indicated by the asterisk) may indicate which version of the function (if multiple versions of the function name exist) to route the fx call 104. In another embodiment, version mapping 108 may not include an active field, and may instead by default choose the highest version number or most recently added or updated version of the function (e.g., FX 1). In another embodiment, different versions may be associated with different clients 106, such that version mapping 108 may include a client field (not shown) which may be checked to determine which version is associated with the requested device, user account, or client 106.

Each version of the function may include a location indicator as described above that point to or otherwise indicate an address or location of the corresponding implementation 114A, 114B of that version. Implementations 114 may include executable code, a virtual machine, or may otherwise call the function (FX 1) corresponding to fx call 104 to be executed on a server or other computing or processing device. While only two versions and two implementations 114 of FX 1 are illustrated in the example of FIG. 1, other functions or web services 103 may include only a single version or three or more versions or implementations 114.

In an embodiment, the location may point to a thread responsible for executing the implementation 114 of the corresponding version of the function. If the thread is busy, then a fx call 104 from client 106 may wait in a queue until the thread and processing resources are available to execute fx call 104. In an embodiment, different clients 106 may have different priorities based on which the client fx calls 104 are queued. In an embodiment, the implementations 114 may each be operating on different computing devices.

Once fx call 104 is transferred to or received by a particular implementation 114, the implementation 114 may respond directly with client 106 without being routed back to version mapping 108 or RVC 102. For example, while web services 103 are illustrated as being part of RAT 102, as referenced throughout, in other embodiments, web services 103 (and implementations 114) may be operational across different computing devices.

Web services 103 may comprise any different number of publicly available functions that clients 106 can call or request in accordance with a public API 112 (that includes definitions of the functions). Developers may occasionally update (e.g., update 105) one or more of those functions without changing the function definitions (e.g., as indicated in public API 112). This way clients 106 who are relying on the public API 112 to call or request particular functionality do not need to change anything about how they are currently using or making fx calls 104 and RVC 102 may enable a seamless integration of updates 105 without service or client interruption.

The end user or clients 106 may not be aware of which implementation or location of that implementation to which the fx call 104 is being routed by RVC 102. In an embodiment, a client 106 may be notified of when particular functionality has been updated or which new version has been made live.

Using version mapping 108, RVC 102 enables the updates 105 to be implemented, instantiated, and otherwise made live (and accessible to clients 106) without interrupting the availability of web services 103 or requiring clients 106 to change their operations. When an implementation or version of a function is put into production, even if only a single version of the function is available, the name, version, and location information may be logged in version mapping 108. And when a fx call 104 is received from a client 106, version mapping 108 is checked even if only one version of the function (in one location) is active, live, or otherwise in production and available to clients 106.

When an update 105 (for a new version) is received, RVC 102 enables an administrator to instantiate the new version and update version mapping 108 to include the new version and new location information while the original version is still being accessed. Once the new version is ready, version mapping 108 may be updated, and subsequent calls to the function may be directed to the new location without any downtime or interruption of service. The administrator may allow multiple versions of the function to remain operational simultaneously, or may shut down, remove, or delete older or outdated versions and free those processing resources.

Update 105 may include any bug fixes, code (compiled or uncompiled), patches, new versions, or new implementation of one or more functions of web services 103. Update 105 may include new functionality, may replace existing functionality, or remove functionality. In an embodiment, update 105 may require copying a current/live version and applying a patch or code update to the copy of the live version.

Rather than requiring a system administrator to shut down existing web services 103 to install updates 105 (during which time web service 103 would be unavailable) and restart web services 103, RVC 102 enables the web services 103 to remain available while update 105 is applied without system disruption or service downtime. RVC 102 maximizes the use of available computing resources to provide the greatest uptime while still enabling code or other updates 105 to be applied to web services 103. in an embodiment, an administrator or developer may have access to functionality of a private API through which the user provides updates to version mapping 108.

In an embodiment, RVC 102 may be used to implement updates 105 and provide computing services based on a representational state transfer (REST) architectural style. In REST a set of constraints may be defined and used to create or provide web services 103. Web services 103 based on REST may provide for interoperability between computing systems on the Internet. Web services may allow the requesting computing systems (e.g., client 106) to access resources by calling stateless operations as defined by public API 112.

In an embodiment, update 105 may developed and packaged into a Java Archive (JAR) file. The JAR file may include an aggregate of different Java class files and associated metadata and resources such as text, images, etc.). Using the private API, a developer may call a PUT API REST method providing the endpoint or computing device to update with update 105. The PUT API REST method may then return a version number for version mapping 108 and indication of the corresponding location.

Or, for example, the developer may alternatively call a PATCH API REST method with update 105 which may be used to make changes to existing code (an existing version). In an embodiment, the PATCH API REST method may increment an existing version number with which to update version mapping 108 (along with an indication of the corresponding location). However, the old, pre-updated version may be maintained in case there are bugs with the update 105, and the update needs to be removed or rolled back.

In an embodiment, if an existing function is implemented, configured, moved, or otherwise made available in a new location (e.g., on a new partition, virtual machine, or computing device), then the location indicator of version mapping 108 may be updated to indicate the new location without any service interruption.

If a new function (not previously available or defined by public API 112) is added to web services 103, then that function and its corresponding version, and implementation location information may be added as a new record in version mapping 108, and public API 112 may be updated.

However, in an embodiment, update 105 may include a new implementation with optional arguments that do not require clients 106 to update their operations (that may not have been previously defined in public API 112). This update 105 may also be seamlessly be integrated and instantiated by updating version mapping 108 as described herein. Then, for example, when clients 106 are made available of the new version with optional arguments, RVC 102 may route those fx calls 104 in accordance with version mapping 108.

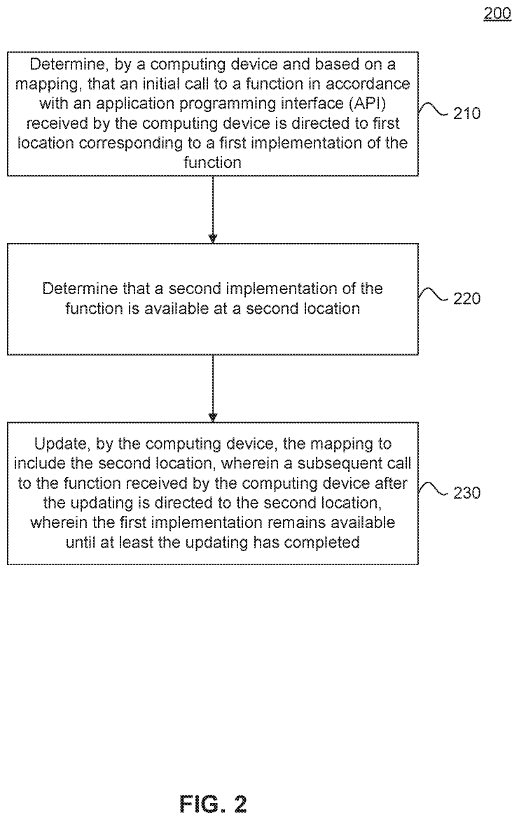

FIG. 2 is a flowchart 200 illustrating example operations of a real-time version controller (RVC) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to the example embodiments.

In 210, it is determined by a computing device and based on a mapping, that an initial call to a function in accordance with an application programming interface (API) received by the computing device is directed to first location corresponding to a first implementation of the function. For example, RVC 102 may be operating on a server that receives fx calls 104 (in accordance with public API 112) from different clients 106. Based on version mapping 108, the fx calls 104 may be routed to a first location (loc 1).

In 220, it is determined a second implementation of the function is available at a second location. For example, RVC 102 may receive update 105 which may be installed, instantiated, or otherwise made available at a second location (loc 2). In an embodiment, RVC 102 may receive a request (via a private API—that is not available to clients 106) to add update 105 to version mapping 108.

In 230, the mapping is updated to include the second location, wherein a subsequent call to the function received by the computing device after the updating is directed to the second location, wherein the first implementation remains available until at least the updating has completed. For example, RVC 102 may update version mapping 108 to indicate both version 1 and version 2 are available at location 1 and location 2, respectively. However, subsequent fx calls 104 may be routed to location 2 at it is the active or most recent version in version mapping 108.

In an embodiment, RVC 102 may continue to route some fx calls to location 1. For example, a subset of clients 106 may continue to have access to version 1, while another subset of clients 106 is provided access to version 2. Then, for example, version mapping 106 may include a client column to determine which clients 106 have access to which version. an embodiment, this may be done as a temporary measure to test version 2 on a subset of clients 106 before rolling it out to all the clients 106. Then, for example, an empty set in the client field may indicate that the versions are available to call clients 106.

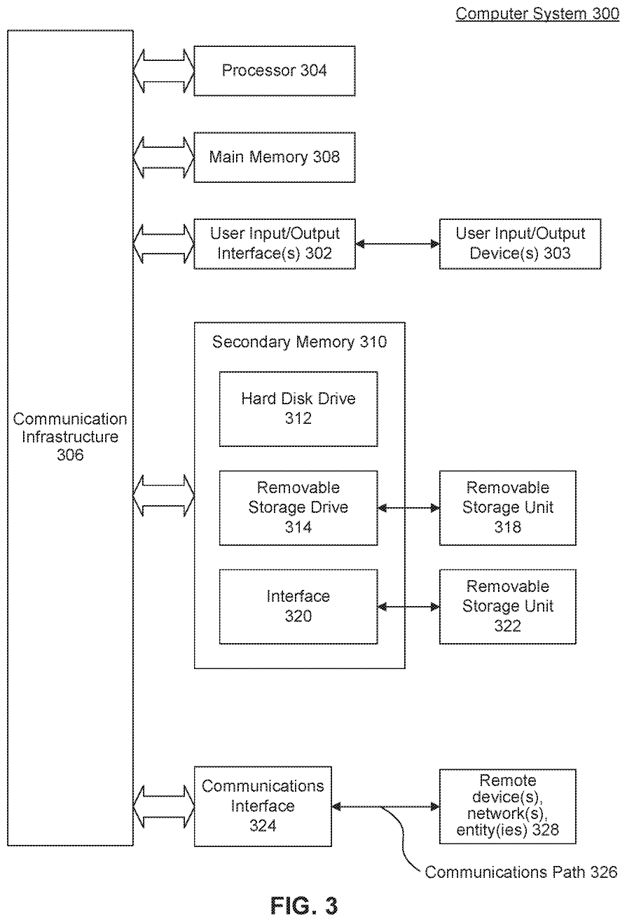

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), Message hack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method comprising:
determining, by a computing device and based on a mapping, that an initial call to a function in accordance with an application programming interface (API) received by the computing device is directed to first location corresponding to a first implementation of the function;
determining that a second implementation of the function is available at a second location;
updating, by the computing device, the mapping to include the second location, wherein a subsequent call to the function received by the computing device after the updating is directed to one of the first location or the second location, wherein the first implementation remains available;
receiving a request to execute the function from a requester; and
determining whether to execute the first implementation or the second implementation based an identity of the requester.

2. The method of claim 1, wherein the updating comprises:
allocating resources of the computing to instantiate the second implementation while the first implementation remains available to one or more client devices with access to the API.

3. The method of claim 1, wherein the first location and the second location correspond to a first memory location and a second memory location, respectively, on the computing device.

4. The method of claim 1, wherein the second implementation includes an update to the first implementation.

5. The method of claim 4, wherein the second implementation receives arguments identical to arguments of the first implementation in accordance with the API.

6. The method of claim 1, wherein the first location and the second location correspond to a first virtual machine and a second virtual machine, respectively, operating on the computing device.

7. The method of claim 6, further comprising:
stopping the first virtual machine from operating on the computing device after the mapping is updated to include the second location.

8. A system comprising:
a memory; and
at least one processor coupled to the memory and configured to:
determine, by the at least one processor and based on a mapping, that an initial call to a function in accordance with an application programming interface (API) received by the at least one processor is directed to first location corresponding to a first implementation of the function;
determining that a second implementation of the function is available at a second location; and
updating, by the at least one processor, the mapping to include the second location, wherein a subsequent call to the function received by the computing device after the updating is directed to one of the first location or the second location, wherein the first implementation remains available;
receiving a request to execute the function from a requester; and
determining whether to execute the first implementation or the second implementation based an identity of the requester.

9. The system of claim 8, wherein the at least one processor that updates is configured to:
allocate resources of the computing to instantiate the second implementation while the first implementation remains available to one or more client devices with access to the API.

10. The system of claim 8, wherein the first location and the second location correspond to a first memory location and a second memory location, respectively, on the computing device.

11. The system of claim 8, wherein the second implementation includes an update to the first implementation.

12. The system of claim 11, wherein the second implementation receives arguments identical to arguments of the first implementation in accordance with the API.

13. The system of claim 8, wherein the first location and the second location correspond to a first virtual machine and a second virtual machine, respectively, operating on the computing device.

14. The system of claim 13, wherein the at least one processor is further configured to:
stop the first virtual machine from operating on the computing device after the mapping is updated to include the second location.

15. A non-transitory computer-readable device having instructions stored thereon that, when executed by at least one computing device, cause the at least one computing device to perform operations comprising: determining, by the at least one computing device and based on a mapping, that an initial call to a function in accordance with an application programming interface (API) received by the at least one computing device is directed to first location corresponding to a first implementation of the function;
determining that a second implementation of the function is available at a second location; and
updating, by the at least one computing device, the mapping to include the second location, wherein a subsequent call to the function received by the computing device after the updating is directed to one of the first location or the second location, wherein the first implementation remains available;
receiving a request to execute the function from a requester; and
determining whether to execute the first implementation or the second implementation based an identity of the requester.

16. The device of claim 15, wherein the at least one computing device that updates is configured to perform operations comprising:
allocating resources of the computing to instantiate the second implementation while the first implementation remains available to one or more client devices with access to the API.

17. The device of claim 15, wherein the first location and the second location correspond to a first memory location and a second memory location, respectively, on the computing device.

18. The device of claim 15, wherein the second implementation includes an update to the first implementation.

19. The device of claim 18, wherein the second implementation receives arguments identical to arguments of the first implementation in accordance with the API.

20. (canceled)

21. The method of claim 1, further comprising:
removing a reference to the first implementation at the first location from the mapping, wherein the identity of the requester is associated with the first implementation;
receiving a subsequent request to execute the function from the requester; and
directing the subsequent request from the requester to the second implementation at the second location.
